(19) United States
(12) Patent Application Publication
(10) Pub. No.: US 2010/0180450 A1
(43) Pub. Date: Jul. 22, 2010

(54) RETRACTABLE BLADE CARPET KNIFE

(76) Inventor: Gary E. Van Deursen, Essex, CT (US)

Correspondence Address: MCDERMOTT WILL & EMERY LLP, 600 13TH STREET, N.W., WASHINGTON, DC, 20005-3096, US

(21) Appl. No.: 12/688,456

(22) Filed: Jan. 15, 2010

Related U.S. Application Data
(60) Provisional application No. 61/193,994, filed on Jan. 16, 2009.

(51) Int. Cl. B26B 5/00; B26B 1/08

(52) U.S. Cl. 30/162; 30/339

(57) ABSTRACT

A knife includes a handle having a blade containing portion for mounting a substantially flat blade, an opening in a terminal end of the blade containing portion through which an end of the blade can project, a blade retainer inside the blade containing portion, having a first projection selectively engagable with a corresponding cutout in the blade for removably retaining the blade, and a blade release member having a second projection. The blade release member is mounted in the blade containing portion and movable in a direction substantially perpendicular to the major plane of the flat blade such that the second projection contacts and flexes the blade to disengage the first projection and the blade cutout to disengage the blade retainer from the blade. This allows removal of the blade from the blade holder via the opening.

### CROSS REFERENCE TO PROVISIONAL APPLICATION

This application is based upon and claims the benefit of priority from Provisional U.S. Patent Application 61/193,994 filed on Jan. 16, 2009, the entire contents of which are incorporated by reference herein.

### TECHNICAL FIELD

The present disclosure relates to carpet knives. The present disclosure has particular applicability to carpet knives with standard replaceable blades and blade storage.

### BACKGROUND

In the tool art there are numerous types of hand held cutting implements that utilize a replaceable blade in one end thereof with an internal storage of additional blades. These knives have a pair of handle members generally abutting at a median plane which are held together by a releasable fastener such that a blade is clamped between the halves in a cutting position. Also, the handle halves conventionally have a storage region that is utilized to hold additional blades. The two halves are typically held together with a bolt and a nut which requires the use of a screwdriver or like instrument for separating the two halves of the handle.

Extra blades can be stored in a compartment within the main frame of the utility knife. However, a number of utility knives have many movable parts which makes them difficult to use and expensive to manufacture. In some of these utility knives removal and replacement of the blade is a complicated operation which may required the use of special tools or tedious dissembling and then reassembling of the utility knife to affect changing of the blade, which is inconvenient to the user.

### SUMMARY

To overcome the disadvantages discussed above, the present application is directed to a utility carpet knife that allows for easy and safe replacing of the blade.

One embodiment of the present disclosure is a knife comprising a handle having a blade containing portion for mounting a substantially flat blade, an opening in a terminal end of the blade containing portion through which an end of the blade can project, a blade retainer inside the blade containing portion having a first projection selectively engagable with a corresponding cutout in the blade for removably retaining the blade, and a blade release member having a second projection. The blade release member is mounted in the blade containing portion and movable in a direction substantially perpendicular to the major plane of the flat blade such that the second projection contacts and flexes the blade to disengage the first projection and the blade cutout, to disengage the blade retainer from the blade. This allows removal of the blade from the blade holder via the opening.

Additional advantages and other features of the present disclosure will be set forth in part in the description which follows and in part will become apparent to those having ordinary skill in the art upon examination of the following or may be learned from the practice of the disclosure. The advantages of the disclosure may be realized and obtained as particularly pointed out in the appended claims.

As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

Reference is made to the attached drawings, wherein elements having the same reference numeral designations represent like elements throughout, and wherein:

FIG. 1 is a front perspective view of a retractable blade knife of FIG. 1;

FIG. 2 is a front view of the knife of FIG. 1;

FIG. 3 is side view of the knife of FIG. 1;

FIG. 4 is a top view of the knife of FIG. 1;

FIG. 5 is a bottom view of the knife of FIG. 1;

FIG. 6 is a cutaway side view of a knife according to an embodiment of the present disclosure;

FIG. 7 is another cutaway side view of a knife according to an embodiment of the present disclosure;

FIG. 8 is another cutaway side view of a knife according to an embodiment of the present disclosure;

FIGS. 9-11 are views of the internal components of a knife according to an embodiment of the present disclosure.

### DETAILED DESCRIPTION

One embodiment of the retractable blade knife of the present disclosure is for use with a standard carpet knife blade, which blade has an overall rectangular shape, two opposed sharpened edges for cutting, and an oblong slot in its central portion. It should be understood, however, that other types of blades are usable with the knife of this disclosure; that is, the disclosure is not limited to a carpet knife.

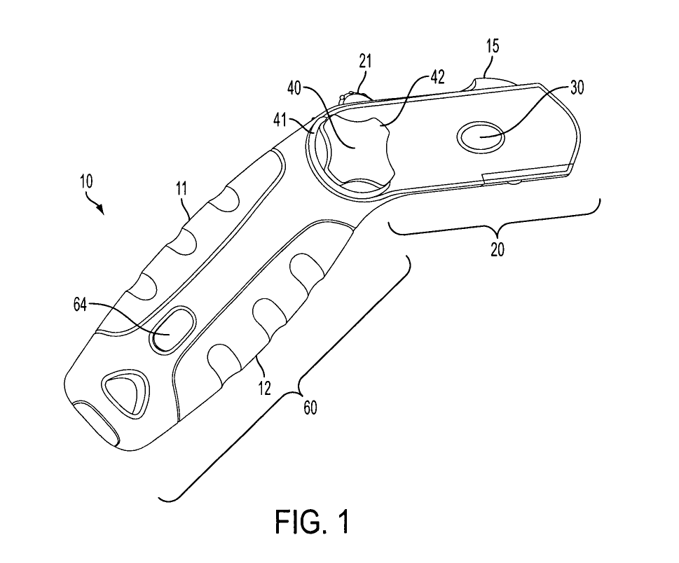

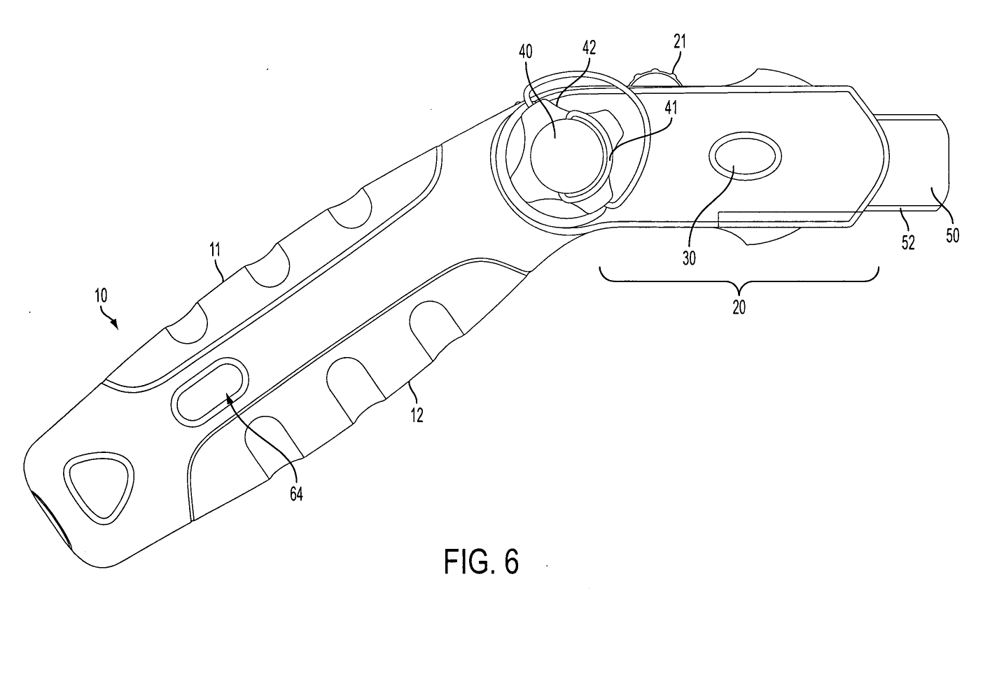

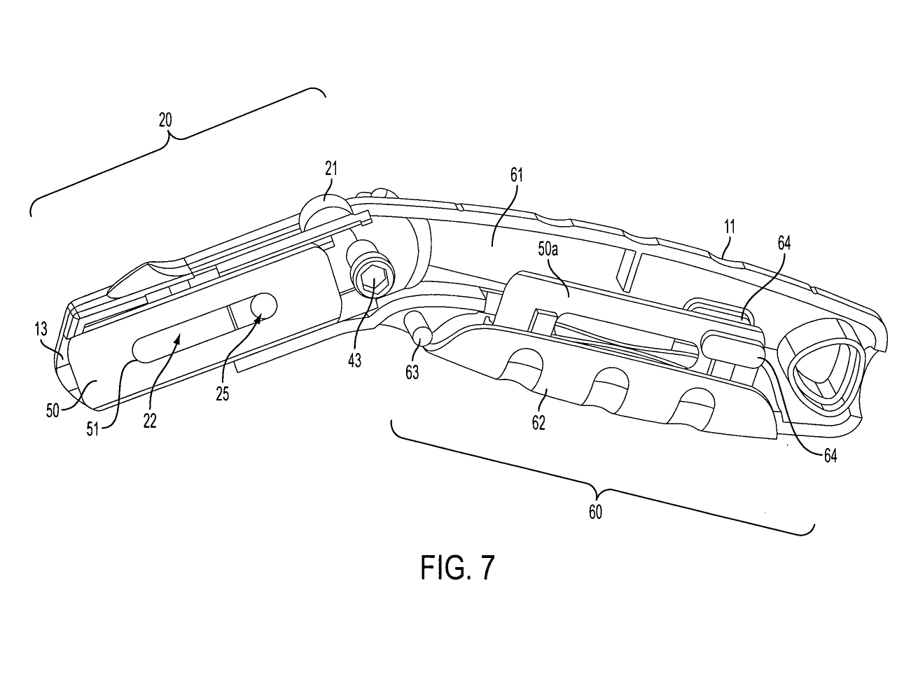

A utility knife according to an embodiment of the present disclosure will now be described with reference to the drawings. FIG. 1 shows a knife comprised of a handle 10 with an upper grip 11 and a lower grip 12, having a blade containing portion 20 for mounting a substantially flat blade 50 (see FIGS. 6 and 7), a twist knob 40 for securing the knife blade 50 in the blade containing portion 20, and a handle storage compartment 60 for storing additional blades. The twist knob 40 additionally comprises at least one lobe portion 42 for tightening the twist knob 40. Additionally, the twist knob 40 comprises a bail 41 for tightening the twist knob 40, the bail 41 being attached on opposite side portions of the twist knob 40. The handle comprises a raised portion 15 on the blade containing portion 20 for alerting a user to the proximity of a blade 50.

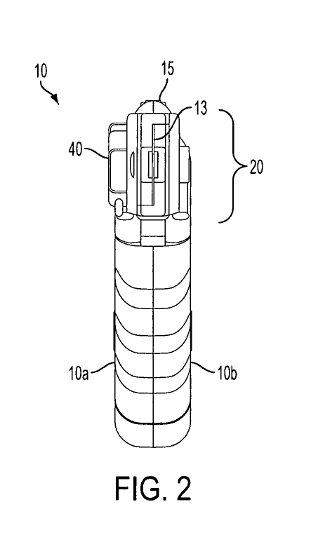

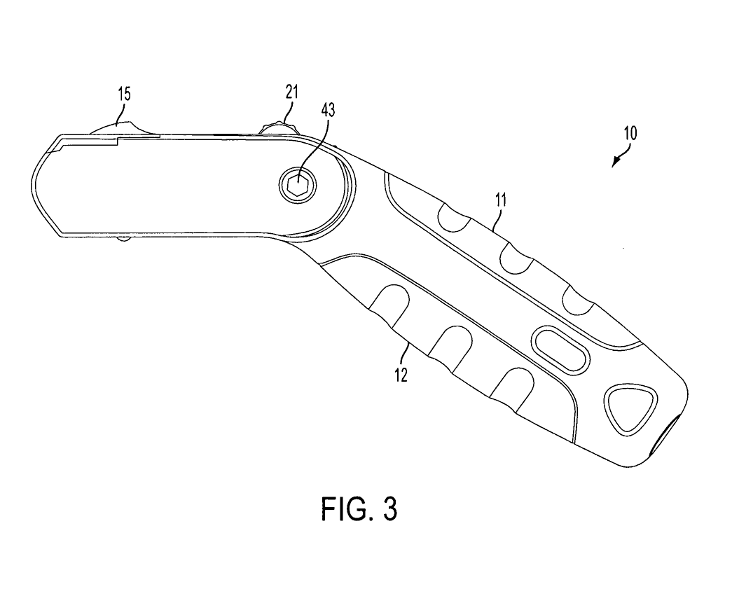

As shown in FIG. 2, the handle 10, comprised of two halves 10a and 10b, has an opening 13 in a terminal end of the blade containing portion 20 through which an end of a blade 50 can project (see FIG. 6). FIG. 3 is a view of the side opposite the twist knob 40, showing the hex nut 43 used to secure the twist knob 40 to the handle 10.

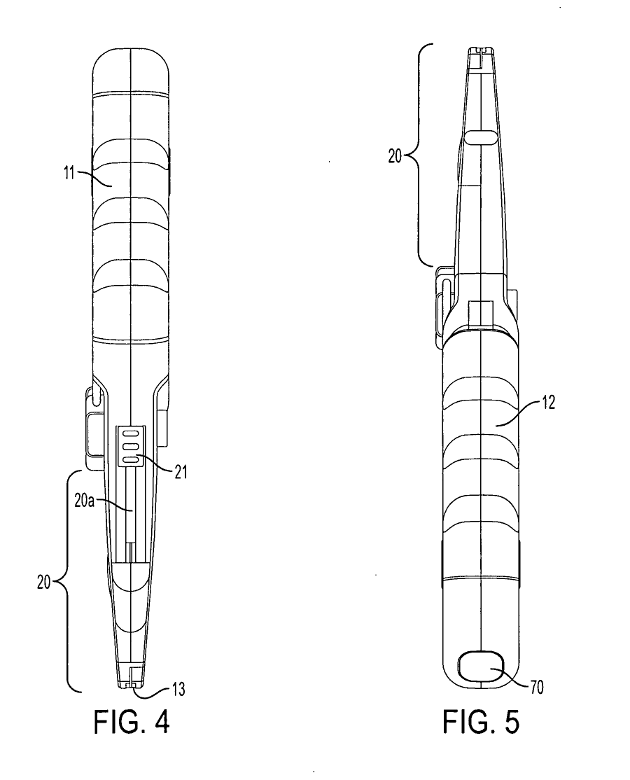

FIGS. 4 and 5 are the top and bottom views of the knife respectively. FIG. 4 shows the slot 20a in the blade containing portion 20 which provides an area for a blade slide button 21 to slide toward the opening 13 thereby allowing the blade 50 to extend from the blade containing portion 20. FIG. 5 shows an impact area 70 on the terminal end of the handle opposite the blade containing portion 20 to hammer down tacks, etc.

FIG. 6 shows the blade 50, having a sharp edge 52, extended out from the blade containing portion 20. The knife includes twist knob 40 having at least one lobe 42 to facilitate turning and tightening down on a blade 50 held between the two housing halves 10a and 10b. The twist knob 40 also has a half round bail 41 that can be flipped out to grip and turn. The bail 41 can lay flat against the handle 10, held with a detent on the knob lobe 42. Certain embodiments, as shown in FIG. 1, feature a large bail 41, and other embodiments, as shown in FIG. 6, have a somewhat smaller bail.

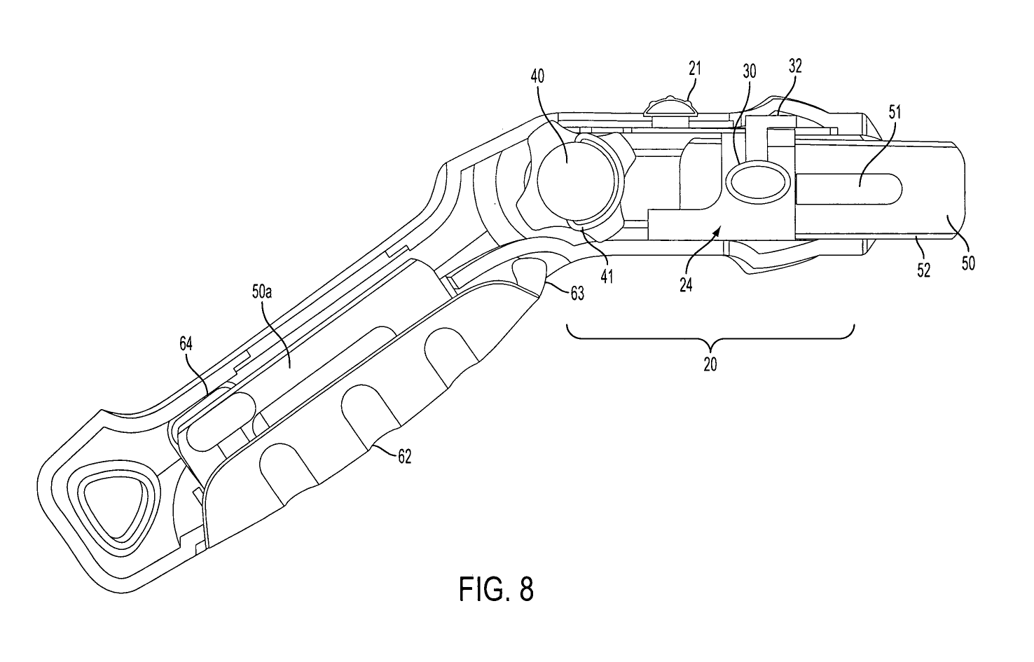

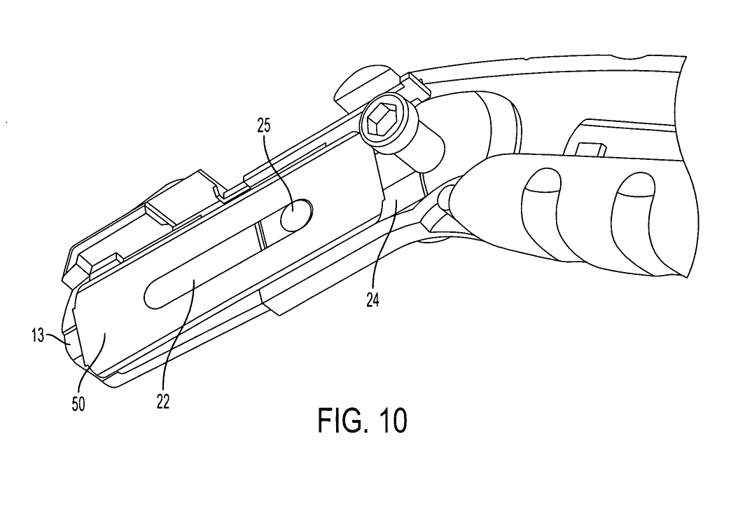

FIGS. 7 and 8 show internal features of the disclosed knife. A blade retainer 24 rests inside the blade containing portion 20. The blade retainer 24 is for moving the blade 50 from a retracted position where the blade 50 is completely within the blade containing portion 20 (see, FIG. 7), to an extended position where the end of the blade 50 projects through the opening 13 (see FIG. 8). On the top of the front of the handle 10 is a blade slide button 21 to retract or extend the blade. It is releasable and held in place with detents on the inside of the housing. FIG. 10 shows the blade retainer 24 with a first projection 25 selectively engagable with a corresponding cutout 51 in the blade 50 for removably retaining the blade 50. In this embodiment, the first projection 25 is a post and the cutout 51 is a slot in a central portion of the blade 50, and the post 25 engages an end of the slot 51 to retain the blade 50. The blade retainer 24 comprises a tab 22 adjacent the post 25 for engaging the slot 51 when the post 25 engages the end of the slot 51 to fixedly mount the blade 50 to the blade retainer 24.

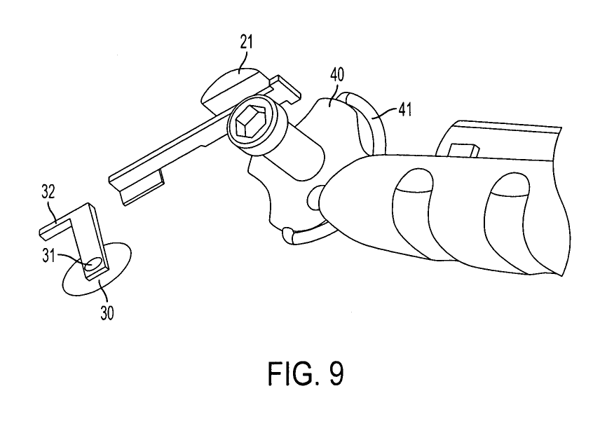

In the extended position, the blade retainer 24 overlaps with a blade release member 30. The blade release member 30 is for allowing removal of the blade 50 when the blade 50 is in the extended position. The blade release member 30 comprises a push button extending through the blade containing portion 20. The blade release member 30 is mounted in the blade containing portion 20 via a flex arm 32 and movable in a direction substantially perpendicular to the major plane of the flat blade 50. FIG. 9 shows the blade release member 30 having a second projection 31 which contacts and flexes the blade 50 when it is in the extended position to disengage the first projection 25 from the blade cutout 51 to disengage the blade retainer 24 from the blade 50, to allow removal of the blade 50 from the blade retainer 24 via the opening 13 (see FIG. 8).

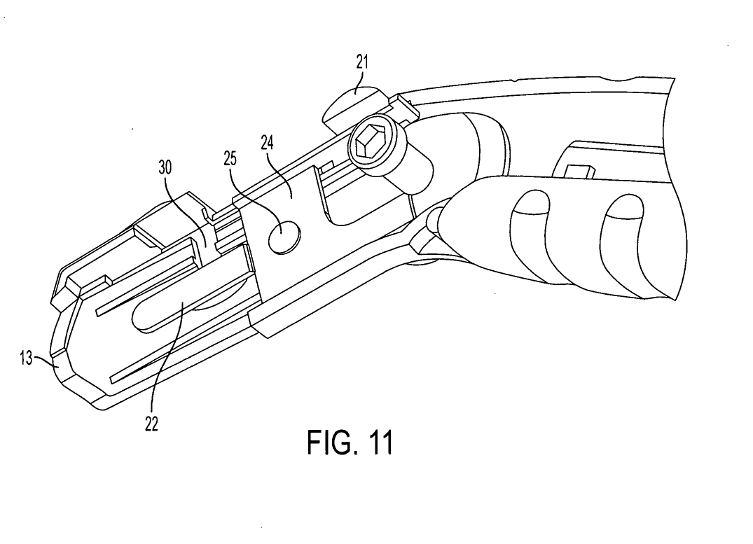

A blade 50 is also insertable into the blade containing portion 20 (when blade containing portion 20 does not have a blade in it) by pressing the blade release member 30 and inserting the blade 50 into the opening 13. As shown in FIGS. 10 and 11, in one embodiment, the tab 22 comprises a ramp for guiding the blade 50 such that the post 25 engages the end of the slot when the blade end is inserted in the opening 13 and slid over the ramp 22. The ramp 22 allows the blade 50 to flex and slide over the post 25 until it detents into place. Additionally, the ramp 22 holds the blade 50 in place.

FIGS. 7 and 8 show a blade storage portion 60 for storing an additional blade 50a, the blade storage portion 60 having a cavity 61 and a door 62, wherein the door 62 is removably attached to the handle 10 with a hinge 63 and the door 62 is disengageably secured to the handle 10 with a release device 64. The blade storage portion 60 can be made of plastic with a soft grip, or be cast metal to match the handle 10.

The present disclosure can be practiced by employing conventional materials, methodology and equipment. Accordingly, the details of such materials, equipment and methodology are not set forth herein in detail. In the previous descriptions, numerous specific details are set forth, such as specific materials, structures, chemicals, processes, etc., in order to provide a thorough understanding of the disclosure. However, it should be recognized that the present disclosure can be practiced without resorting to the details specifically set forth. In other instances, well known processing structures have not been described in detail, in order not to unnecessarily obscure the present disclosure.

Only a few examples of the present disclosure are shown and described herein. It is to be understood that the disclosure is capable of use in various other combinations and environments and is capable of changes or modifications within the scope of the inventive concepts as expressed herein.

What is claimed is:

1. A knife comprising:
a handle having a blade containing portion for mounting a substantially flat blade;
an opening in a terminal end of the blade containing portion through which an end of the blade can project;
a blade retainer inside the blade containing portion, having a first projection selectively engagable with a corresponding cutout in the blade for removably retaining the blade; and
a blade release member having a second projection, the blade release member being mounted in the blade containing portion and movable in a direction substantially perpendicular to the major plane of the flat blade such that the second projection contacts and flexes the blade to disengage the first projection and the blade cutout to disengage the blade retainer from the blade, to allow removal of the blade from the blade holder via the opening.

2. The knife of claim 1, further comprising a twist knob for securing the knife blade in the blade containing portion.

3. The knife of claim 2, wherein the twist knob further comprises a lobe portion for tightening the twist knob.

4. The knife of claim 2, wherein the twist knob further comprises a bail for tightening the twist knob, the bail being attached on opposite side portions of the twist knob.

5. The knife of claim 1, wherein the blade retainer is for moving the blade from a retracted position where the blade is completely within the blade containing portion, to an extended position where the end of the blade projects through the opening.

6. The knife of claim 5, wherein the blade release member is for allowing removal of the blade when the blade is in the extended position.

7. The knife of claim 1, wherein the blade release member comprises a push button extending through the blade containing portion.

8. The knife of claim 1, wherein the first projection is a post and the cutout is a slot in a central portion of the blade, and the post engages an end of the slot to retain the blade.

9. The knife of claim 8, wherein the blade retainer further comprises a tab adjacent the post for engaging the slot when the post engages the end of the slot to fixedly mount the blade to the blade retainer.

10. The knife of claim 9, wherein the tab comprises a ramp for guiding the blade such that the post engages the end of the slot when the blade end is inserted in the opening and slid over the ramp.

11. The knife of claim 1, wherein the handle further comprises a blade storage portion for storing an additional blade, the blade storage portion having a cavity and a door, wherein the door is removably attached to the handle with a hinge and the door is disengageably secured to the handle with a release device.

12. The knife of claim 1, further comprising an impact area on the terminal end of the handle opposite the blade containing portion.

13. The knife of claim 1, further comprising a raised portion on the blade containing portion for alerting a user to the proximity of a blade.

14. The knife of claim 6, wherein the first projection is a post and the cutout is a slot in a central portion of the blade, and the post engages an end of the slot to retain the blade.

15. The knife of claim 14, wherein the blade retainer further comprises a tab adjacent the post for engaging the slot when the post engages the end of the slot to fixedly mount the blade to the blade retainer.

16. The knife of claim 15, wherein the tab comprises a ramp for guiding the blade such that the post engages the end of the slot when the blade end is inserted in the opening and slid over the ramp.
